(19) United States
(12) Patent Application Publication
(10) Pub. No.: US 2025/0029583 A1
(43) Pub. Date: Jan. 23, 2025

(54) Electronic Musical Instrument Operating Device

(71) Applicant: Ef-Note Inc., Hamamatsu-shi (JP)

(72) Inventor: Kazuaki INOUE, Hamamatsu-shi (JP)

(21) Appl. No.: 18/905,497

(22) Filed: Oct. 3, 2024

Related U.S. Application Data
(63) Continuation of application No. PCT/JP2023/013771, filed on Apr. 3, 2023.

(30) Foreign Application Priority Data
Apr. 11, 2022 (JP) 2022-065405

(51) Int. Cl. G10H 1/34

(52) U.S. Cl. CPC G10H 1/34; G10H 2220/096; G10H 2220/101

(57) ABSTRACT

An electronic musical instrument operating device has a display configured to display a current value of any parameter of the electronic musical instrument. A touch panel input is configured to receive input of a desired value of the parameter of the electronic musical instrument. A display control configured to display the desired value in a second display form. A reflection part is configured to reflect the desired value on the current value, provided that a relevant operation is performed by an operator. A determining part is configured to determine whether the parameter has been changed to the desired value. The display control restores the desired value displayed in the second display form on the display to the first display form, provided that the parameter is determined to be changed to the desired value.

### CROSS-REFERENCE TO RELATED APPLICATIONS

This application is a continuation of International Application PCT/JP2023/013771, filed Apr. 3, 2023, which claims priority to Japanese Application No. 2022-065405, filed Apr. 11, 2022. The disclosures of the above applications are incorporating herein by reference.

### FIELD

The present disclosure relates to an electronic musical instrument operating device capable of operating any parameter related to output of a sound source part included in an electronic musical instrument.

### BACKGROUND

An electronic musical instrument is configured to, based on hitting sound of a particular natural musical instrument such an acoustic drum or an acoustic cymbal, previously store waveform data obtained at the time of hitting and to output the previously stored waveform data upon detection of hitting during a performance. Such an electronic musical instrument normally includes a sound source part that outputs from a speaker or a headphone any sound based on hitting during a performance.

For example, Japanese Unexamined Patent Application Publication No. 2018-159769 and Japanese Unexamined Patent Application Publication No. 2018-159770 disclose an electronic musical instrument operating device where an operator can freely operate parameters (such as sound volume and sound effects) related to the output of a sound source part included in an electronic musical instrument. The electronic musical instrument operating device displays the parameters of an authenticated electronic musical instrument on the touch panel display screen. A touch operation on a predetermined section (button looking display section) on the screen allows the sound volume and pitch to be increased or decreased. A slider moving on another section (slider looking display section) upward or downward while touching the slider allows the sound volume and pitch to be adjusted in real time.

### SUMMARY

However, since a touch operation on the touch panel is reflected on the electronic musical instrument in real time in the above-mentioned conventional electronic musical instrument operating device, when a player touches the touch panel unintentionally by mistake during a performance of the electronic musical instrument, a parameter may be changed to an extreme value. Thus, equipment may be damaged due to interruption of the performance or excessive sound volume. In a process of operating a parameter, a control signal, for changing the parameter, is transmitted and received successively and frequently. This may have adverse effects on a sound generation process and a sound generation speed of a sound source part.

The present disclosure has been made in view of above-described situation. It is an object of the present disclosure to provide an electronic musical instrument operating device configured to, even when a player touches the touch panel unintentionally by mistake, avoid change of any parameter to an extreme value. Also, it prevents adverse effects on the sound generation process and the sound generation speed of a sound source part.

An electronic musical instrument operating device is configured to operate any parameter related to output of a sound source part included in an electronic musical instrument. The electronic musical instrument operating device comprises a display configured to display a current value of the parameter of the electronic musical instrument in a first display form. A touch panel input part is configured to receive input of a desired value of the parameter of the electronic musical instrument. A display control part is configured to display the desired value of the parameter of the electronic musical instrument, received by the input part in a second display form different from the first display form. A reflection part is configured to reflect the change in the parameter of the electronic musical instrument from the current value to the desired value, provided that a relevant operation is performed by an operator. The display control part restores the desired value displayed in the second display form on the display to the first display form, provided that a reflection operation is performed causing the parameter of the electronic musical instrument to reflect the desired value.

A determining part is provided in the electronic musical instrument operating device. The determining part is configured to determine whether the parameter of the electronic musical instrument is changed to the desired value. The display control part restores the desired value displayed in the second display form on the display to the first display form, provided that the parameter of the electronic musical instrument is determined to be changed to the desired value by the determining part.

In the electronic musical instrument operating device, the electronic musical instrument includes a plurality of performance parts. The display control part is configured to individually control display of the plurality of performance parts.

An electronic musical instrument operating device is configured to operate any parameter related to output of a sound source part included in an electronic musical instrument. The electronic musical instrument operating device comprises a display configured to display a current value of the parameter of the electronic musical instrument. A touch panel input part is configured to receive input of a desired value of the parameter of the electronic musical instrument. A display control part is configured to, upon input of a desired value of the parameter of the electronic musical instrument received by the input part, change a first display state to a second display state, and display the presence or absence of the desired value. A reflection part configured to reflect the change in the parameter of the electronic musical instrument from the current value to the desired value, provided that a relevant operation is performed by an operator. A restoring part is configured to restore the desired value that has not been reflected on the electronic musical instrument to the current value, provided that a relevant operation is performed by an operator. A determining part is configured to determine the presence or absence of the desired value that has not been reflected on the electronic musical instrument. The display control part restores values displayed in the second display state on the display to the first display state, provided that the determining part determines the absence of the desired value that has not been reflected on the electronic musical instrument.

The input part is configured to receive input of a plurality of desired values. Each valve is the desired value of the parameter of the electronic musical instrument. The reflection part causes parameters to collectively reflect the plurality of desired values, provided that a relevant operation is performed by an operator.

The parameter includes sound volume, sound quality, music sound, sound effect, setting of an output destination of the electronic musical instrument, and adjustment items of the performance parts.

The electronic musical instrument operating device is comprised of an external operating terminal connected, by a wire or wirelessly, to the sound source part of the electronic musical instrument.

According to the disclosure, a reflection part is configured to reflect the change in the parameter of the electronic musical instrument from the current value to the desired value, provided that a relevant operation is performed by an operator. Thus, even when a player touches the touch panel unintentionally by mistake, unless the player performs an operation on the reflection part, the parameter is not changed from the current value to the desired value. Thus, change of the parameter to an extreme value can be avoided. Accordingly, since successive reflection is not performed on the parameter in an operation process and only the desired value is reflected on the parameter, it is possible to prevent adverse effects on the sound generation process and the sound generation speed of the sound source part.

A determining part is configured to determine whether the parameter of the electronic musical instrument is changed to the desired value. The display control part restores the desired value displayed in the second display form on the display to the first display form, provided that the parameter of the electronic musical instrument is determined to be changed to the desired value by the determining part. Thus, an operator can be notified of change of the parameter of the electronic musical instrument to the desired value. Meanwhile, when it is determined that the parameter of the electronic musical instrument does not normally reflect the desired value for some reason, the desired value continues to be displayed in the second display form. Thus, the operator can again try to reflect the desired value on the parameter.

The electronic musical instrument includes a plurality of performance parts. The display control part is configured to individually control display of the plurality of performance parts. Thus, the disclosure can be favorably applied to an electronic musical instrument having a plurality of performance parts, such as an electronic drum.

The input part is configured to receive input of a plurality of desired values. Each value is the desired value of the parameter of the electronic musical instrument. The reflection part causes the parameter to collectively reflect the plurality of desired values, provided that a relevant operation is performed by an operator. Thus, as compared to an electronic musical instrument where each parameter is successively reflected on a desired value, a plurality of parameters can be changed instantaneously. This reduces the inconvenience of successive operations of reflection, and desired values of a plurality of parameters to be simultaneously changed can be checked for reflection.

The parameter includes sound volume, sound quality, music sound, sound effect, setting of an output destination of the electronic musical instrument, and adjustment items of the performance parts. Thus, an operation to the reflection part allows these parameters to reflect desired values rather than from current values.

The electronic musical instrument operating device is comprised of an external operating terminal connected, by a wire or wirelessly, to the sound source part of the electronic musical instrument. Thus, the electronic musical instrument operating device can be disposed at any position different from the position of the sound source part. The operability of the electronic musical instrument operating device can be further improved.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram illustrating an electronic musical instrument operating device according to a first embodiment.

FIG. 2 is a schematic view illustrating a performance part and a sound source part used in the electronic musical instrument operating device.

FIG. 3 is a flowchart representing a control process executed by the electronic musical instrument operating device.

FIG. 4 is a flowchart representing a control process executed by the electronic musical instrument operating device.

FIG. 5 is a schematic view illustrating the electronic musical instrument operating device (external operating terminal).

FIG. 6 is a schematic view illustrating the electronic musical instrument operating device (external operating terminal).

FIG. 7 is a schematic view illustrating the electronic musical instrument operating device (external operating terminal).

FIG. 8 is a schematic view illustrating the electronic musical instrument operating device (external operating terminal in another form).

FIG. 9 is a schematic view illustrating the electronic musical instrument operating device (external operating terminal in another form).

FIG. 10 is a schematic view illustrating the electronic musical instrument operating device (external operating terminal in another form).

FIG. 11 is a schematic view illustrating the electronic musical instrument operating device (external operating terminal in another form).

FIG. 12 is a schematic view illustrating the electronic musical instrument operating device (external operating terminal in another form).

FIG. 13 is a schematic view illustrating the electronic musical instrument operating device (external operating terminal in another form).

FIG. 14 is a schematic view illustrating the electronic musical instrument operating device (external operating terminal in another form).

FIG. 15 is a schematic view illustrating the electronic musical instrument operating device (external operating terminal in another form).

FIG. 16 is a block diagram illustrating an electronic musical instrument operating device according to a second embodiment.

FIG. 17 is a schematic view illustrating the electronic musical instrument operating device (external operating terminal).

FIG. 18 is a schematic view illustrating the electronic musical instrument operating device (external operating terminal).

FIG. 19 is a block diagram illustrating an electronic musical instrument operating device according to another embodiment.

FIG. 20 is a schematic view illustrating a performance part and a sound source part used by the electronic musical instrument operating device.

### DETAILED DESCRIPTION

Hereinafter, embodiments of the present disclosure will be concretely described with reference to the drawings.

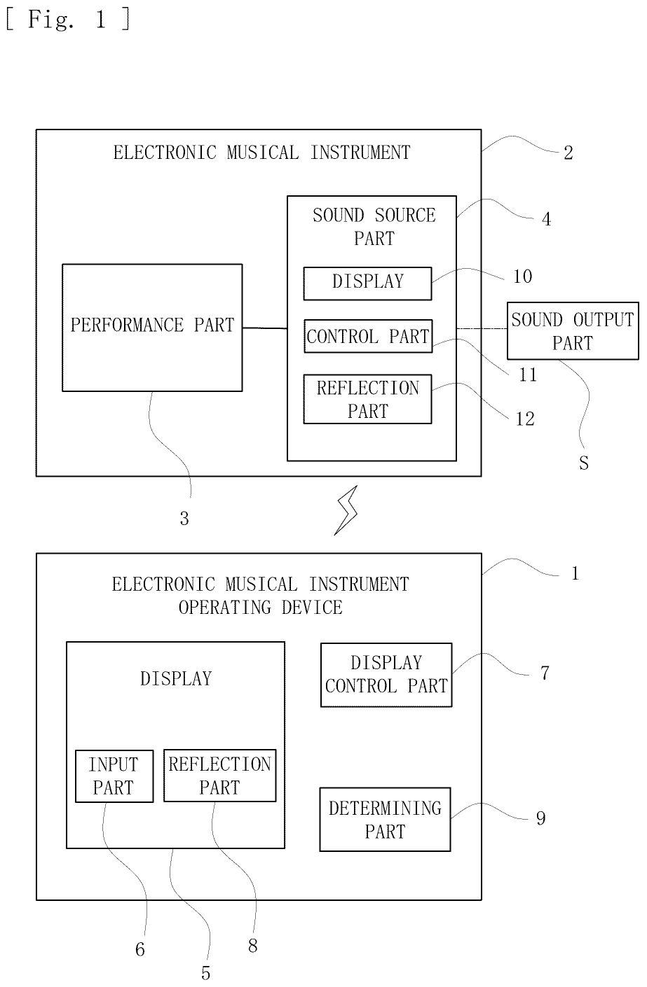

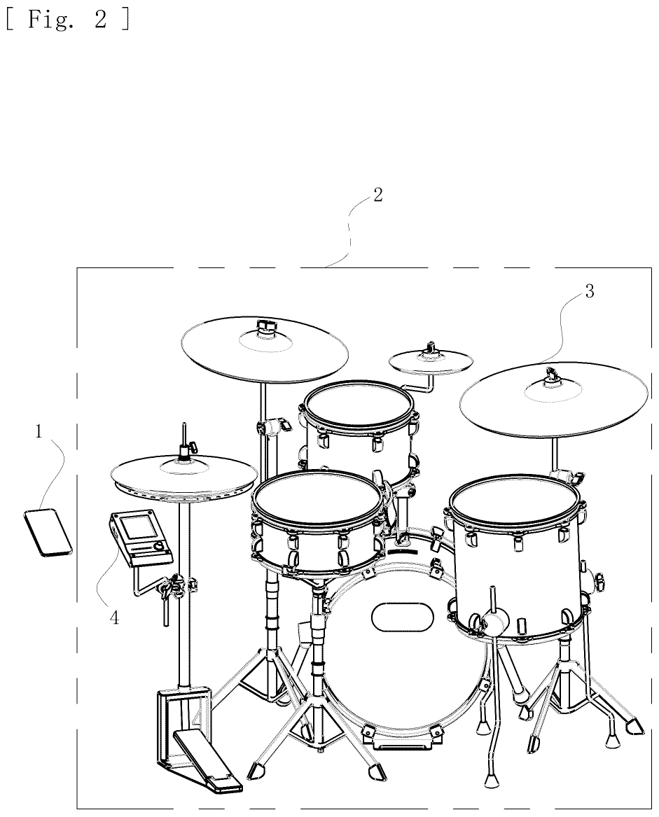

An embodiment of the present disclosure will be specifically described below with reference to the drawings. As illustrated in FIGS. 1 and 2, an electronic musical instrument operating device 1, according to a first embodiment, is formed as a separate component from a sound source part 4 of an electronic musical instrument 2. It includes an external operating terminal wirelessly connected. In the present embodiment, information (such as control signals) necessary for a performance can be transmitted and received between the electronic musical instrument operating device 1 and the sound source part 4 by e.g., radio waves and infrared rays. However, the electronic musical instrument operating device 1 and the sound source part 4 may be connected by a wire.

The electronic musical instrument 2 can electronically create hitting sounds and output them during a performance. In the present embodiment, the electronic musical instrument 2 includes a performance part 3 including electronic drum and an electronic cymbal. They can be played by a player hitting the electronic drum and the electronic cymbal with a stick or the like. The performance part 3 of the electronic musical instrument 2 may be, in addition to percussion instruments such as the electronic drum and the electronic cymbal, another electronic musical instrument, for example, a keyboard instrument such as an electronic piano or a string instrument such an electronic guitar.

The performance part 3 includes a hitting portion to be hit during a performance. A vibration sensor is configured to detect a hit on the hitting portion during the performance and to transmit a detection signal. The detection signal, detected by the vibration sensor, is transmitted to the sound source part 4.

When receiving the detection signal from the performance part 3, the sound source part 4 can output an output signal according to the detection signal to a sound output part S such as a speaker and a headphone.

In addition, the sound source part 4 includes a display 10 configured to display any parameter related to the electronic musical instrument 2. A control part 11 is configured to control the parameter of the electronic musical instrument 2. A reflection part 12 is configured to reflect the change in the parameter of the electronic musical instrument 2 from the current value to the desired value. The parameters of the electronic musical instrument 2 include the sound volume, sound quality, music sound, sound effect, setting of an output destination of the electronic musical instrument 2, and the adjustment items of the performance part 3, and these are freely adjustable.

For example, when the performance part 3 is hit during the performance, a detection signal, due to the hit, is transmitted to the sound source part 4, which generates an output signal corresponding the detection signal. A desired music sound is output from the sound output part S and a parameter such as sound volume is displayed on the display 10. When a desired value is input to a parameter of the electronic musical instrument 2, by operating the reflection part 12, the parameter can be changed from the current value to the desired value by the control of the control part 11.

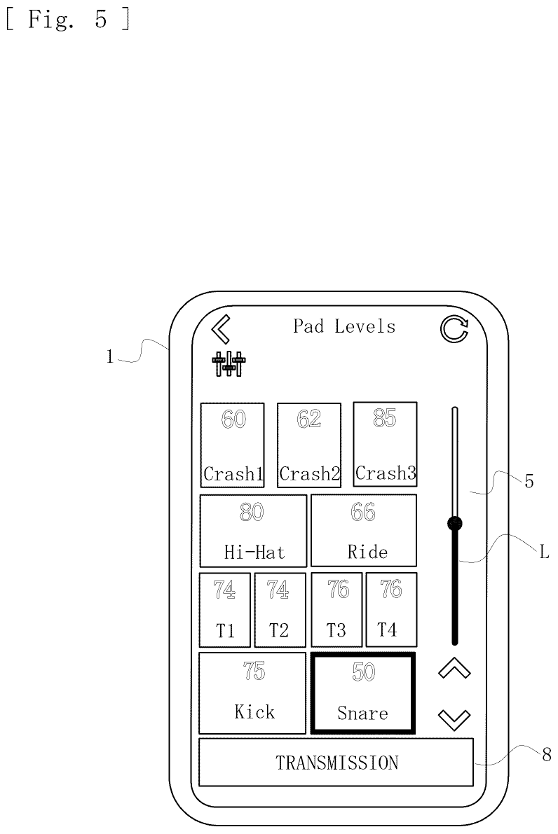

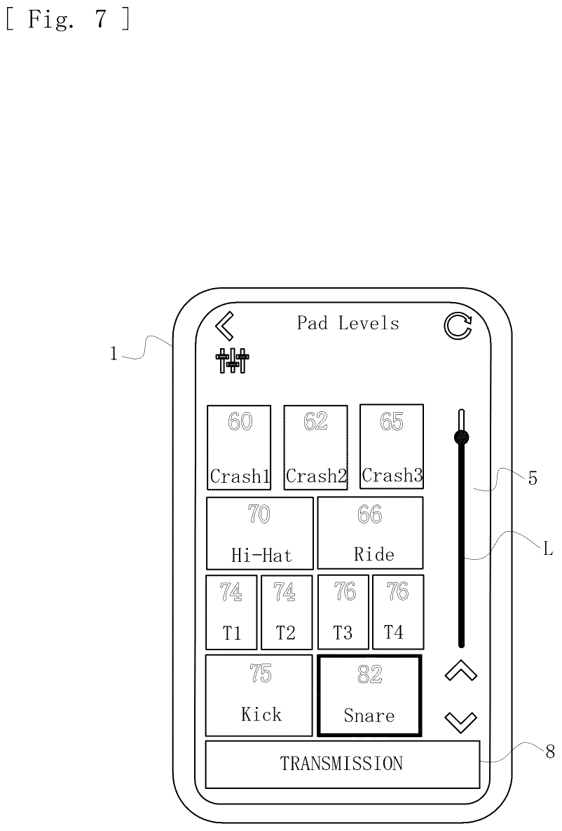

Meanwhile, the electronic musical instrument operating device 1 has an external operating terminal (see FIGS. 5 to 7) wirelessly connected to the sound source part 4 of the electronic musical instrument 2. Thus, any parameter (the sound volume, sound quality, music sound, sound effect, setting of an output destination of the electronic musical instrument 2, and the adjustment items of the performance part 3) related to the output of the sound source part 4, included in the electronic musical instrument 2, is remotely controllable. The electronic musical instrument operating device 1 includes a display 5. The display 5 includes a display screen, an input part 6, a display control part 7, a reflection part 8 and a determining part 9. The input part 6 is configured to receive input by detecting a touch operation to the display 5. The display control part 7 is a microcomputer. The reflection part 8 is configured to receive a touch operation by an operator. The determining part 9 is a microcomputer.

The display 5 displays the current values of the parameters of the electronic musical instrument 2 in the first display form. It has a liquid crystal screen configured to display various characters, numbers and designs as illustrated in FIGS. 5 to 7, for example. As illustrated in FIGS. 5 to 7, on the display 5, a plurality of sections (areas) indicating respective performance parts 3 are displayed. The characters, such as “Crash1”, “Hi-Hat”, “Ride”, “T1”, “Kick”, “Snare”, to grasp the type of each performance part 3, are displayed in the sections.

In the present embodiment, any parameter (a numeral indicating sound volume in FIGS. 5 to 7) of the performance part 3 is displayed in a section (area) indicating the performance part 3. The current value of the parameter is displayed (in the first display form) with an open numeral. For example, in FIG. 5, the current value of sound volume of “Crash3” of the electronic musical instrument 2 is “85”. The current value of sound volume of “Hi-Hat” is “80”. The current value of sound volume of “Snare” is “50”.

The input part 6 is a touch panel part configured to receive input of a desired value of a parameter of the electronic musical instrument 2. For example, a desired value can be input with a finger by making contact with (touching) a predetermined section displayed on the display 5. For example, input by the input part 6 is performed with a finger by making contact with (touching) a section indicating the performance part 3 whose parameter is to be operated, so that the touched performance part 3 is selectable. When the performance part 3 is selected by the touching, as illustrated in FIGS. 5 to 15, the display range of the selected performance part 3 is surrounded by a bold line. An adjustment portion L is displayed on the display 5, and the parameter of the selected performance part 3 is increased or decreased by moving the adjustment portion L upward or downward while touching the adjustment portion L so that a desired value can be input.

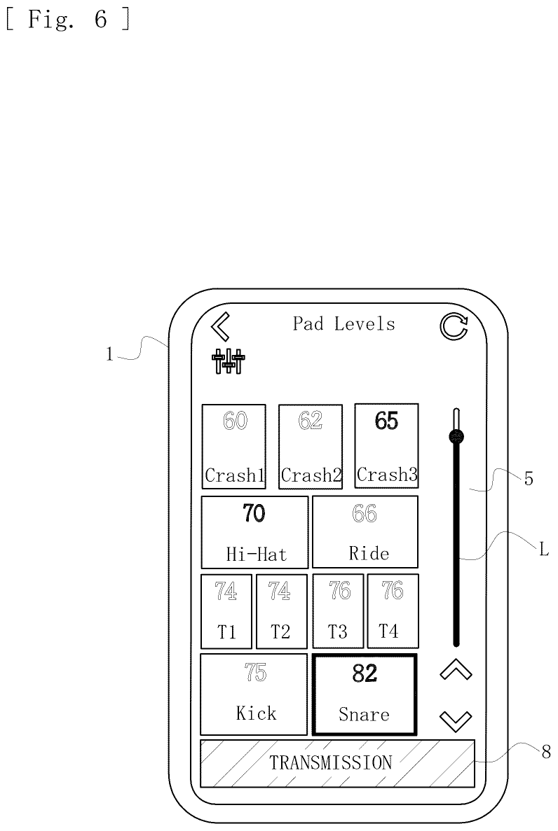

The display control part 7 displays, on the display 5, a desired value of the parameter of the electronic musical instrument 2 received by the input part 6 in the second display form different from the first display form. For example, as illustrated in FIG. 6, a desired value of the parameter is displayed with a solid numeral (in the second display form). Specifically, when a section indicating any performance part 3 is selected by touching the section, then a desired value is input by performing a touch operation on the adjustment portion L. The display control part 7 displays the desired value in the second display form (solid display form) in the section (area) indicating the performance part 3 whose parameter has been changed.

For example, in FIG. 6, the desired value of sound volume of “Crash3”, of the electronic musical instrument 2, is “65”. The desired value of sound volume of “Hi-Hat” is “70”. The desired value of sound volume of “Snare” is “82”. The respective numerals are displayed in the solid display form (the second display form). Note that in the section (area) indicating each performance part 3, whose parameter has not been changed, the open display form (the first display form) for respective numerals is maintained.

The reflection part 8 reflects the change in the parameter of the electronic musical instrument 2 from the current value to the desired value, provided that a relevant operation by an operator is performed. In the present embodiment, a push button looking portion labeled with characters, “transmission” is displayed on the display 5. In other words, when a touch operation is performed on the reflection part 8, in a state where a desired value is displayed in the second display form (the solid display form), information including the desired value of the parameter is transmitted to the sound source part 4 of the electronic musical instrument 2.

When the sound source part 4 of the electronic musical instrument 2 receives the information, including the desired value of the parameter, in the control part 11, the parameter reflects a desired value rather than the current value. The sound volume of the output by the sound output part S is changed to the desired value. For example, in the present embodiment, the sound volume of “Crash3” of the electronic musical instrument 2 is changed from “85” to “65”. The sound volume of “Hi-Hat” is changed from “80” to “70”. The sound volume of “Snare” is changed from “50” to “82”.

The determining part 9 determines whether the parameter of the electronic musical instrument 2 has been changed to the desired value. In the present embodiment, when the change of the parameter is completed in the control part 11, a completion notification signal is transmitted from the sound source part 4. Upon reception of the completion notification signal by the electronic musical instrument operating device 1, the electronic musical instrument operating device 1 requests the sound source part 4 for the current value this time. Thus, it is determined the reflected current value matches the corresponding desired value by the determining part 9. Thus, and it is determined that the parameter of the electronic musical instrument 2 has been changed to the desired value.

Here, the display control part 7, according to the present embodiment, is configured to restore the desired value displayed in the second display form on the display to the first display form, provided that a reflection operation to cause the parameter of the electronic musical instrument 2 to reflect the desired value is performed. Specifically, the display control part 7 causes the parameter to reflect a desired value rather than the current value by performing a touch operation on the reflection part 8. This restores the desired value displayed in the second display form (the solid display form) on the display 5 to the first display form (the open display form), provided that the determining part 9 determines that the parameter of the electronic musical instrument 2 has been changed to the desired value. For example, in the present embodiment, “Crash3”, “Hi-Hat” and “Snare” of the electronic musical instrument 2 in the solid numeral display are returned to the open numeral display.

In addition, the input part 6, according to the present embodiment, is configured to receive input of a plurality of desired values of parameters of the electronic musical instrument 2. The reflection part 8 can cause the parameters to collectively reflect the plurality of desired values, provided that a relevant operation is performed by an operator. In the present embodiment, as illustrated in FIG. 6, desired values of a plurality of parameters “Crash3”, “Hi-Hat” and “Snare” can be input. A touch operation on the reflection part 8 enables desired values of a plurality of parameters “Crash3”, “Hi-Hat” and “Snare” to be collectively transmitted to the sound source part 4 of the electronic musical instrument 2, for reflection.

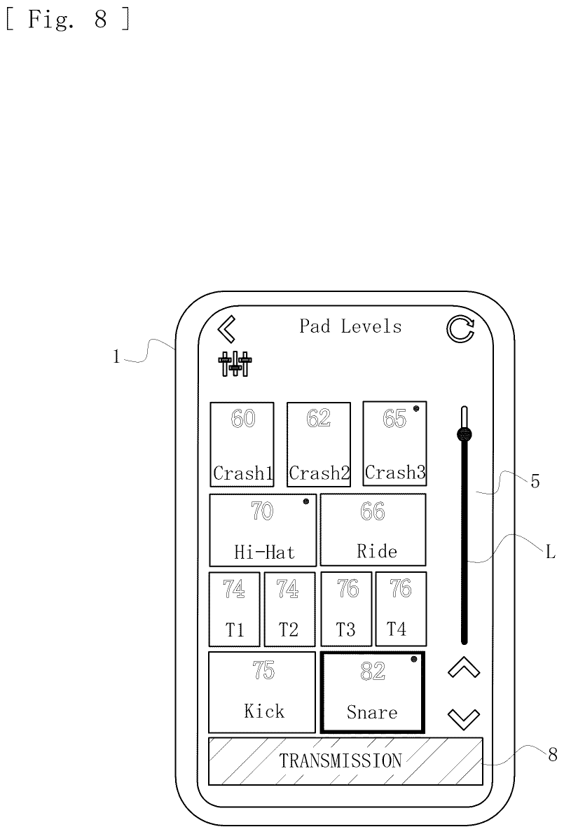

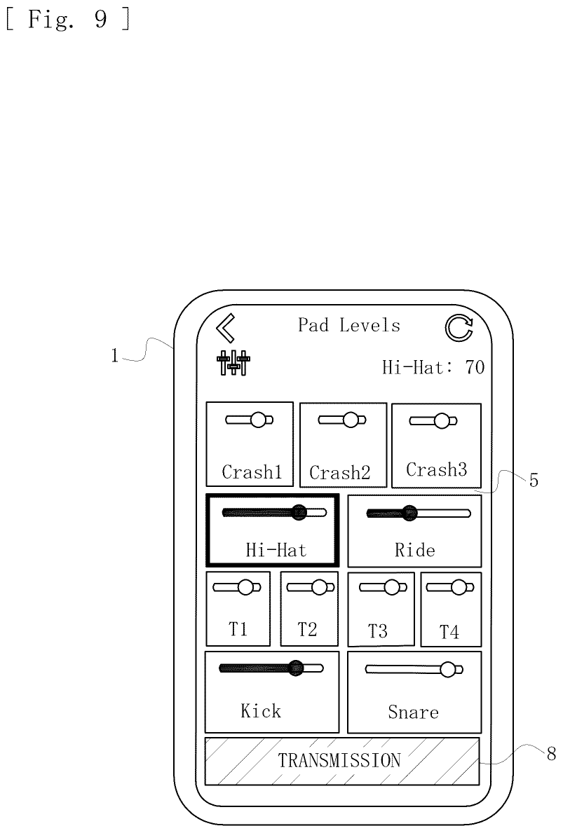

In addition to the first display form and the second display form defined as the open numeral display and the solid numeral display as described above, in the section (area) indicating the performance part 3, the first display form may be the form without display of a circular shape and the second display form may be the form with display of a circular shape as illustrated in FIG. 8. As illustrated in FIG. 9, in the section (area) indicating the performance part 3, a design corresponding to the adjustment part L is each displayed. The first display form may be the form with open display of the design. The second display form may be the form with solid display of the design. In addition, the first display state may be constant display and the second display state may be blinking display.

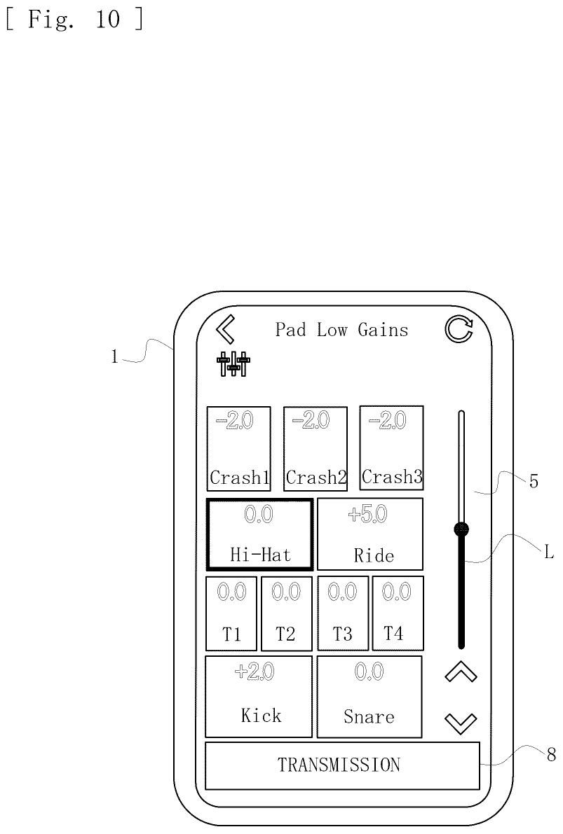

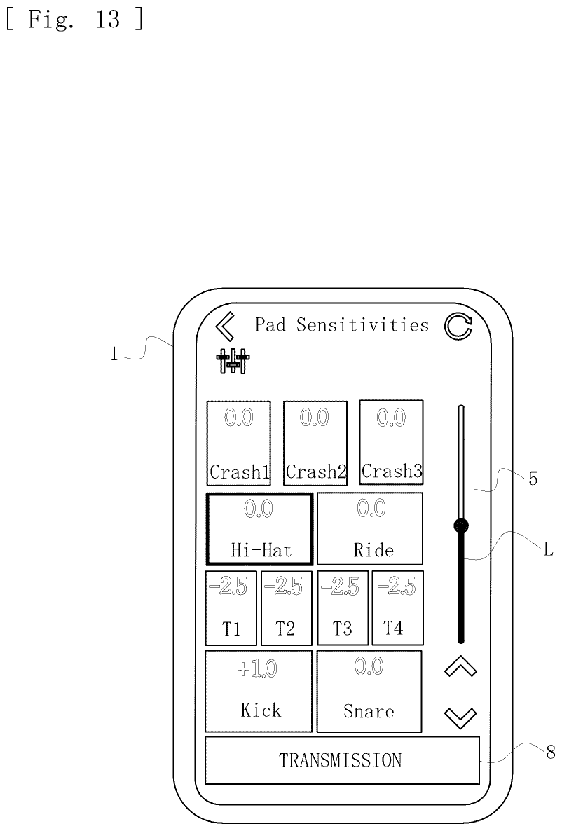

Furthermore, in addition to operation of the sound volume of the electronic musical instrument 2, other parameters may be operable. For example, as illustrated in FIGS. 10 to 12, the sound quality of the electronic musical instrument 2 may be operable, or as illustrated in FIGS. 13 to 15, the sensitivity of the electronic musical instrument 2 may be operable.

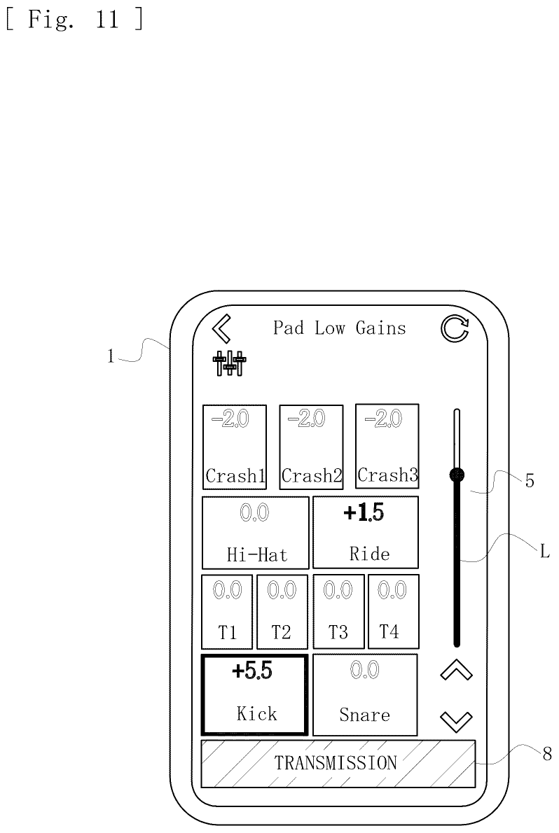

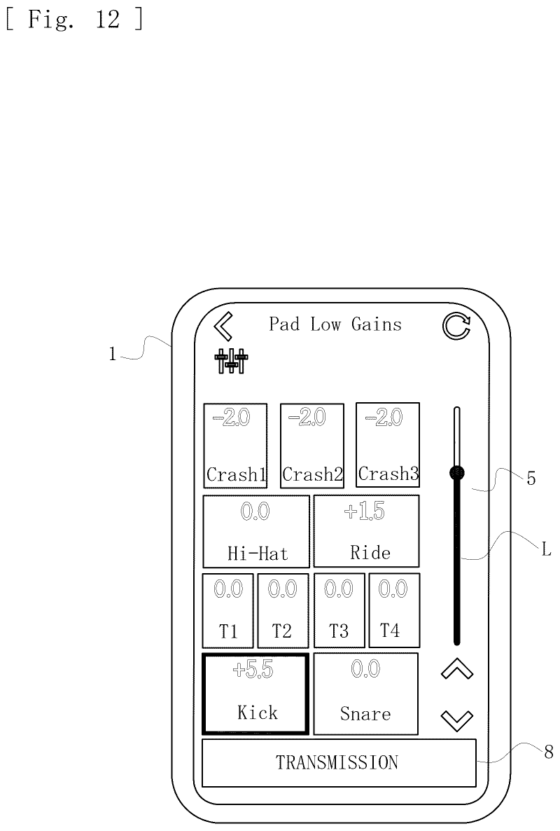

For example, when the sound quality of the electronic musical instrument 2 is operated, as illustrated in FIG. 10, in each section indicating the performance part 3, the current value of sound quality is displayed in the first display form (the open numeral display). As illustrated in FIG. 11, a desired value is input by performing a touch operation on a desired section. The desired value is displayed in the second display form (the solid numeral display). A desired value rather than the current value is reflected on the sound quality by performing a touch operation on the reflection part 8. As illustrated in FIG. 12, the sound quality displayed in the second display form (the solid numeral display) is restored to the first display form (the open numeral display), provided that the reflection result is correct.

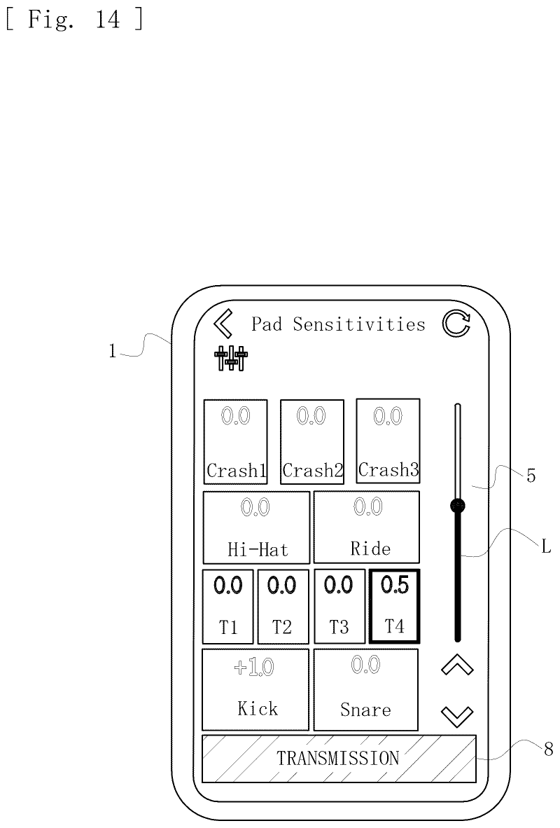

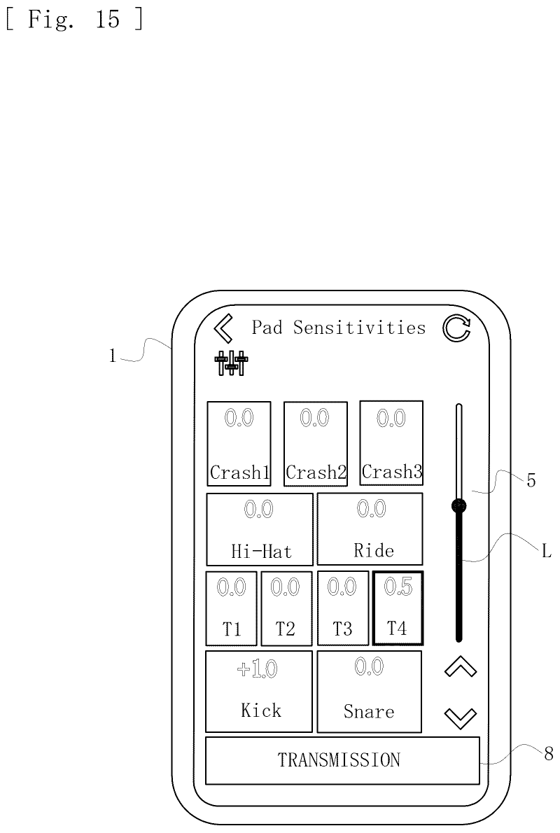

For example, when the sensitivity of the electronic musical instrument 2 is operated, as illustrated in FIG. 13, in each section indicating the performance part 3, the current value of sensitivity is displayed in the first display form (the open numeral display). As illustrated in FIG. 14, a desired value is input by performing a touch operation on a desired section. The desired value is displayed in the second display form (the solid numeral display). The sensitivity is caused to reflect a desired value rather than the current value by performing a touch operation on the reflection part 8. As illustrated in FIG. 15, the sensitivity displayed in the second display form (the solid numeral display) is restored to the first display form (the open numeral display), provided that the reflection result is correct.

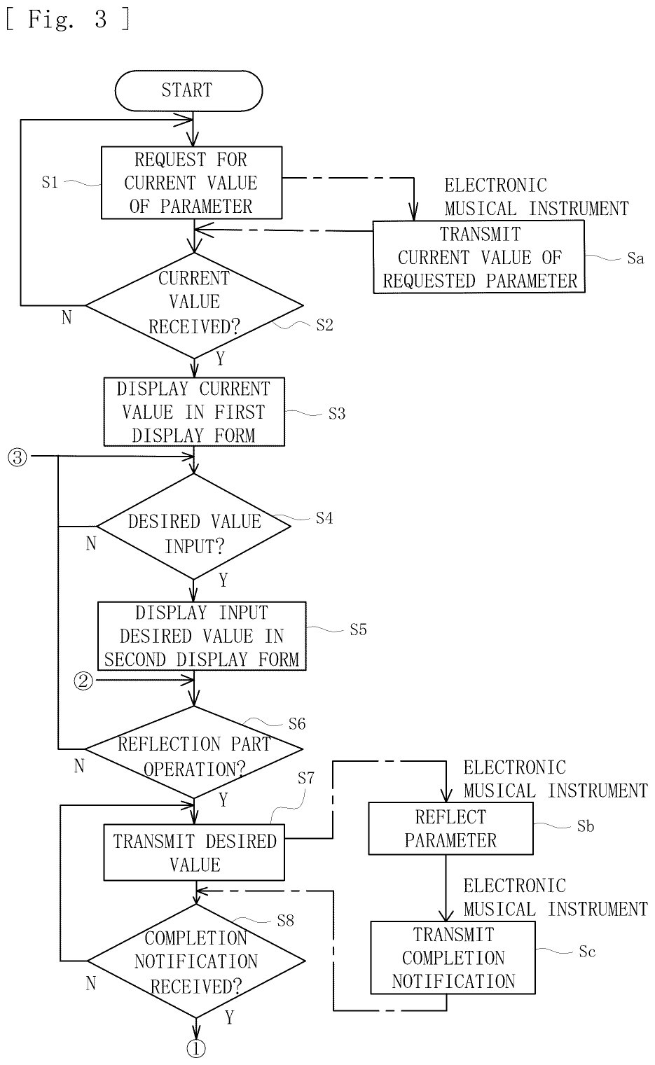

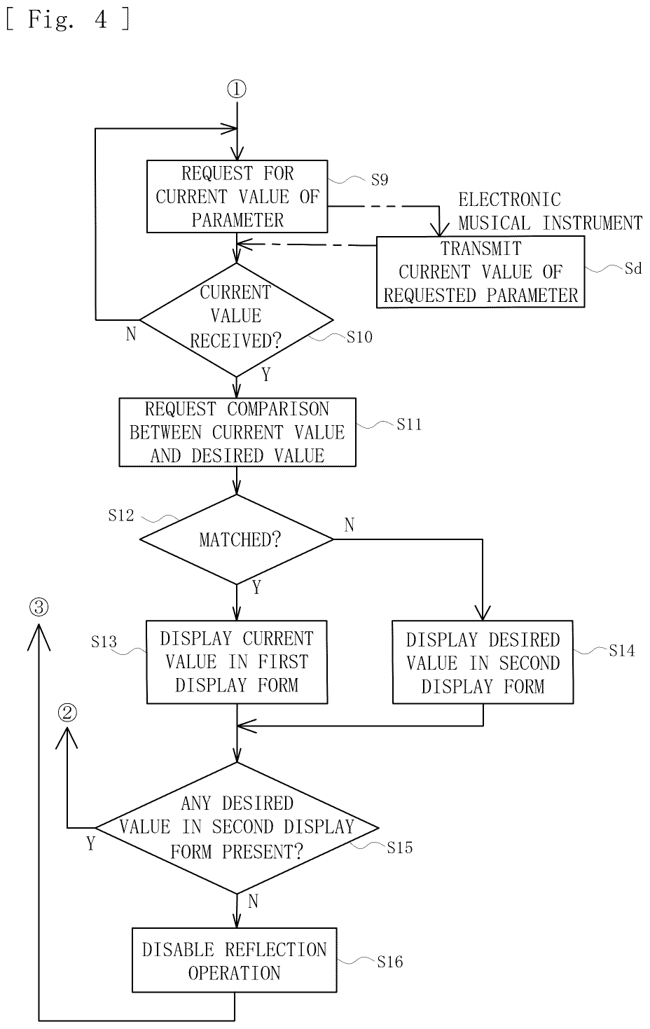

The control process executed by the electronic musical instrument operating device 1, according to the present embodiment, will be described below with reference to the flowcharts illustrated in FIGS. 3, 4. First, in S1, the current value of the parameter is requested from the electronic musical instrument operating device 1 to the sound source part 4. Thus, when receiving a request signal, the sound source part 4 transmits the requested current value of the parameter (Sa). When the electronic musical instrument operating device 1 cannot receive the current value, request for the current value is repeated again, and in this case, the number of times of retry can be set in advance. In S2, it is determined whether the current value has been received, and when the current value is determined to be received, the flow proceeds to S3, and the current value is displayed in the first display form (the open display form) (see FIG. 5). At this point, a touch operation to the reflection part 8 is disabled, and even if an operator touches the reflection part 8 by mistake, an input operation is not performed.

Subsequently, in S4, it is determined whether a desired value has been input, and when a desired value is determined to be input, the flow proceeds to S5. The input desired value is displayed in the second display form (the solid display form) (see FIG. 6). At this point, a touch operation to the reflection part 8 is enabled, and input can be received by a touch operation to the reflection part 8. In S6, the presence or absence of a touch operation to the reflection part 8 is determined. Thus, when a touch operation is determined to be present, in S7, the desired value is transmitted to the electronic musical instrument 2.

When the electronic musical instrument 2 receives the desired value, in Sb, the desired value is reflected. The parameter is changed from the current value to the desired value, then in Sc, a completion notification signal is transmitted to the electronic musical instrument operating device 1. Subsequently, in S8, it is determined whether a completion notification signal has been received, When a completion notification is determined to be received, in S9, the current value of the parameter is requested from the electronic musical instrument operating device 1 to the sound source part 4. When receiving a request signal, the sound source part 4 transmits the requested current value of the parameter (Sd). When the electronic musical instrument operating device 1 cannot receive the completion notification signal, the desired value is transmitted to the electronic musical instrument 2 again. In this case, the number of times of retry can be set in advance.

In S10, it is determined whether the current value has been received, and when the current value is determined to be received, the flow proceeds to S11. The received current value is compared with the desired value, and it is determined in S12 whether the current value received matches the desired value. As a result, matched current value is restored to the first display form (the open display form) in S13, and for an unmatched current value, the desired value is continued to be displayed in the second display form (the solid display form) in S14 (see FIG. 6).

After S13 or S14, in S15, it is determined whether the display of the desired value in the second display form (the solid display form) is present. When display of the desired value in the second display form is determined to be present, the flow returns to S6, and subsequent process is performed again. When display of the desired value in the second display form is determined to be absent, in S16, a touch operation to the reflection part 8 is disabled. The flow returns to S4 and the subsequent process is performed again.

According to the present embodiment, the reflection part 8 is configured to reflect the change in the parameter of the electronic musical instrument 2 from the current value to the desired value, provided that a relevant operation is performed by an operator. Thus, even when a player touches the touch panel unintentionally by mistake, unless the player performs an operation on the reflection part 8, the parameter is not changed from the current value to a desired value, Thus, change of the parameter to an extreme value can be avoided. Successive reflection is not performed on the parameter in an operation process and only the desired value is reflected on the parameter. Thus, it is possible to prevent adverse effects on the sound generation process and the sound generation speed of the sound source part 4.

In addition, the determining part 9 is configured to determine whether the parameter of the electronic musical instrument 2 is changed to the desired value, The display control part 7 restores the desired value displayed in the second display form on the display 5 to the first display form, provided that the parameter of the electronic musical instrument 2 is determined to be changed to the desired value by the determining part 9. Thus, an operator can be notified of change of the parameter of the electronic musical instrument 2 to the desired value. When there is a parameter which has not been changed to the desired value, an operation to cause the parameter to reflect a desired value can be performed again. In particular, the electronic musical instrument 2 includes a plurality of performance parts 3, and the display control part 7 is configured to individually control display of the plurality of performance parts 3. Thus, the disclosure can be favorably applied to an electronic musical instrument with a plurality of performance parts 3, such as an electronic drum.

The input part 6 is configured to receive input of a plurality of desired values of the parameter of the electronic musical instrument 2. The reflection part 8 causes the parameter to collectively reflect the plurality of desired values, provided that a relevant operation is performed by an operator. Thus, as compared to an electronic musical instrument where each parameter is successively changed, a plurality of parameters can be changed instantaneously. Thus, it is possible to prevent adverse effects on the sound generation process and the sound generation speed of the sound source part 4. In the present embodiment, a plurality of desired values are collectively reflected, however, one desired value may be reflected.

Furthermore, the parameters applied to the present embodiment are the sound volume, sound quality, music sound, sound effect, setting of an output destination of the electronic musical instrument 2, and the adjustment items of the performance parts 3. Thus, these parameters can reflect desired values rather than from the current values by an operation to the reflection part 8. The parameters applied are not limited to the sound volume, sound quality, music sound, sound effect, setting of an output destination of the electronic musical instrument 2, and the adjustment items of the performance parts 3, and may be any other parameters. In addition, according to the present embodiment, the electronic musical instrument operating device 1 includes an external operating terminal connected to the sound source part 4 of the electronic musical instrument 2 by a wire or wirelessly. Thus, the electronic musical instrument operating device 1 can be disposed at any position different from the position of the sound source part 4.

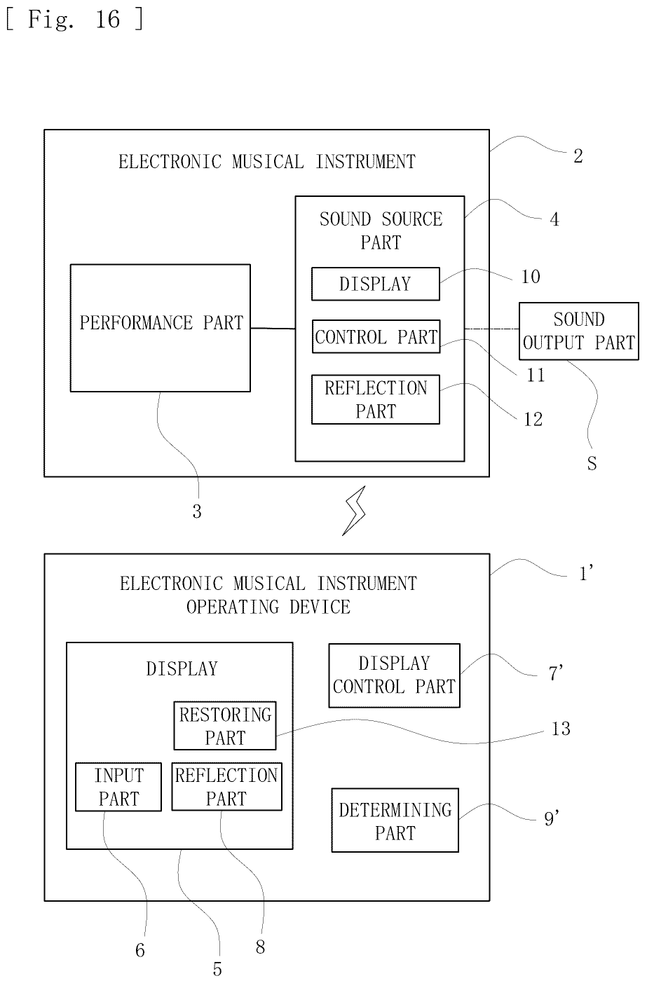

Next, as illustrated in FIGS. 16 to 18, an electronic musical instrument operating device 1 according to a second embodiment is formed as a separate component from the sound source part 4 of the electronic musical instrument 2. It includes an external operating terminal connected wirelessly. In the present embodiment, information (such as control signals) necessary for a performance can be transmitted and received between the electronic musical instrument operating device 1 and the sound source part 4, by e.g., radio waves and infrared rays. Also, the electronic musical instrument operating device 1 and the sound source part 4 may be connected by a wire.

Note that the components (specifically, the display 5, the input part 6 and the reflection part 8) similar to those of the first embodiment are labeled with the same symbol. Thus, a detailed description thereof is omitted. The electronic musical instrument 2 (including the sound source part 4) is applied is similar to that in the first embodiment, and a detailed description of the electronic musical instrument 2 is also omitted.

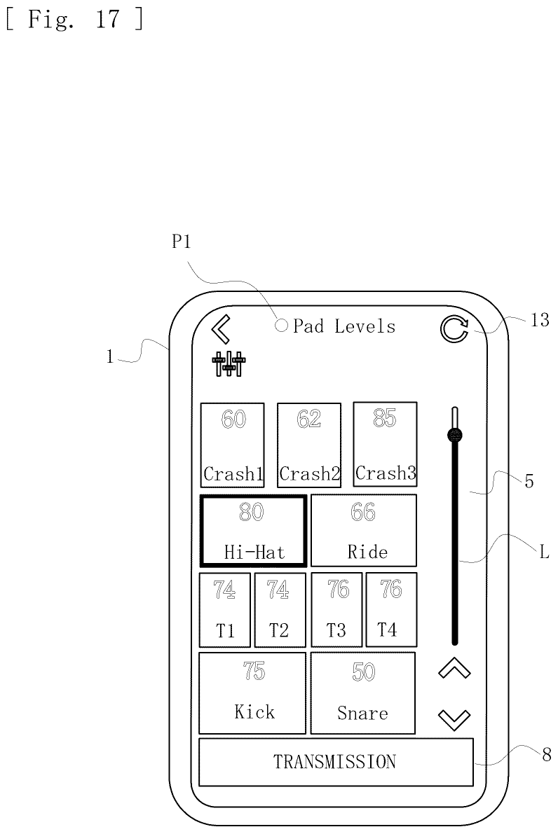

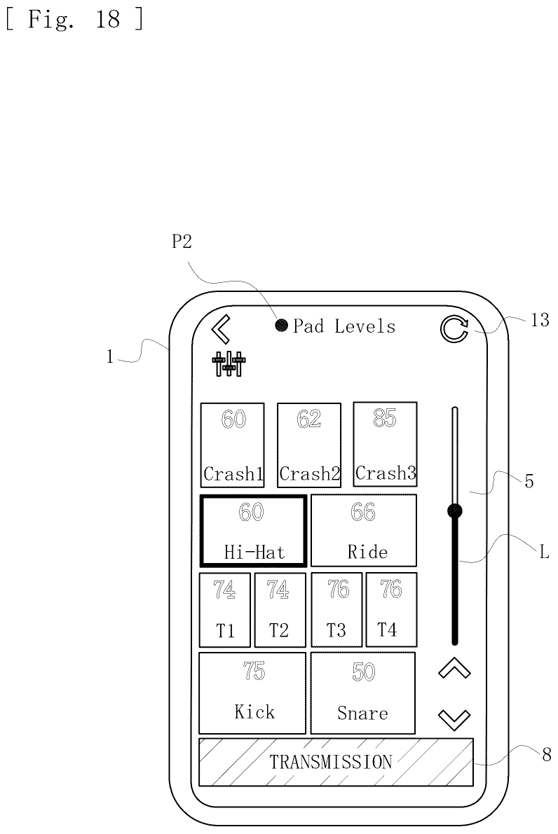

A display control part 7′ is configured to, upon input of a desired value of the parameter of the electronic musical instrument 2 received by the input part 6, change the first display state to the second display state, and display the presence or absence of a desired value. For example, as illustrated in FIGS. 17, 18, when a section indicating any performance part 3 is selected by touching the section, a desired value is input by performing a touch operation on the adjustment portion L. The display control part 7′ changes display at an upper portion of the display 5 from the first display state, where an open circle symbol is displayed, to the second display state, where a solid circle symbol is displayed. At this point, unlike the first embodiment, the display form of the parameters of the desired values is not changed.

Note that the first display state and the second display state are not limited to display of an open circle symbol and a solid circle symbol as mentioned above, and other forms may be displayed at other sections. Alternatively, when a desired value is input, the display state of the reflection part 8 may change, for example, change from display showing that a touch operation is not permitted to display showing that a touch operation is permitted. In this case, the display state where a touch operation in the reflection part 8 is not possible is the first display state, and the display state where transmission by a touch operation is possible is the second display state.

A restoring part 13 is configured to restore a desired value that has not been reflected on the electronic musical instrument 2 to the current value, provided that a relevant operation is performed by an operator. As illustrated in FIGS. 17, 18, the restoring part 13 is displayed at an upper portion of the display 5. It is made operable by an operator performing a touch operation. The restoring part 13, according to the present embodiment, is configured to, upon execution of a touch operation, request the sound source part 4 for the current value, and restore the desired value to the current value by receiving the current value. Alternatively, the current value before input of a desired value is temporarily stored, and the desired value may be restored to the stored current value by performing a touch operation on the restoring part 13.

A determining part 9′ is configured to determine the presence or absence of a desired value that has not been reflected on the electronic musical instrument 2. Here, the display control part 7′, according to the present embodiment, is configured to restore display in the second display state to the first display state. Specifically, it changes the display from the second display form, where a solid circle symbol is displayed, to the first display form, where an open circle symbol is displayed, on the display 5, provided that the determining part 9′ determines the absence of the desired value that has not been reflected on the electronic musical instrument 2.

According to the present embodiment, as in the first embodiment, the reflection part 8 is configured to reflect the change in the parameter of the electronic musical instrument 2 from the current value to the desired value, provided that a relevant operation is performed by an operator. Thus, even when a player touches the touch panel unintentionally by mistake, unless the player performs an operation on the reflection part 8, the parameter does not reflect a desired value rather than from the current value. Thus, change of the parameter to an extreme value can be avoided. Successive reflection is not performed on the parameter in an operation process and only the desired value is reflected on the parameter. Thus, it is possible to prevent adverse effects on the sound generation process and the sound generation speed of the sound source part 4.

According to the present embodiment, the restoring part 13 is provided. Thus a desired value can be restored to the current value as needed. Therefore, even in a condition where the first display state and the second display state cannot be switched for display for each performance part 3 due to limitation of color or space, if an operator forgot which performance part 3 has been operated by himself or herself, the state before change can be easily restored, thus accurate input of a desired value is possible. In the present embodiment, a plurality of desired values are collectively reflected, however, one desired value may be reflected.

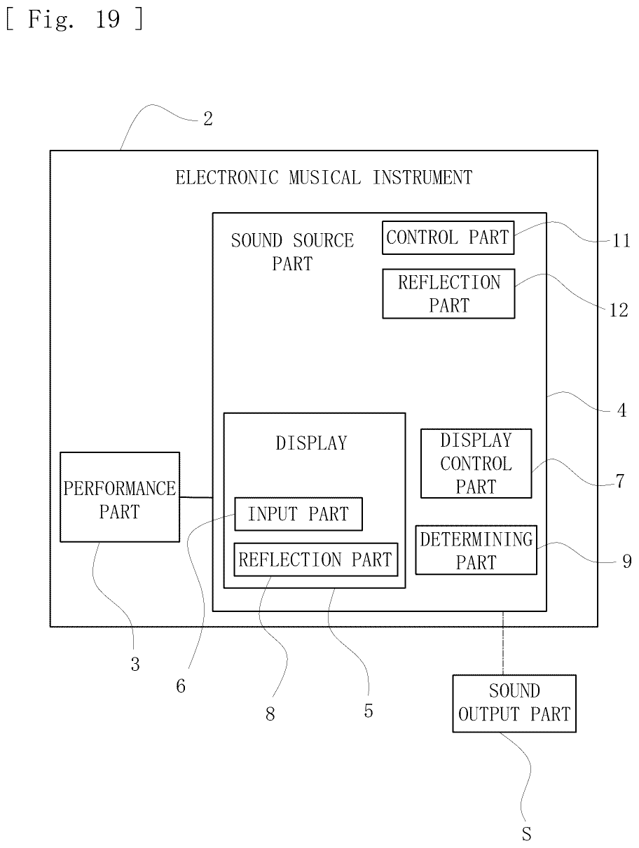

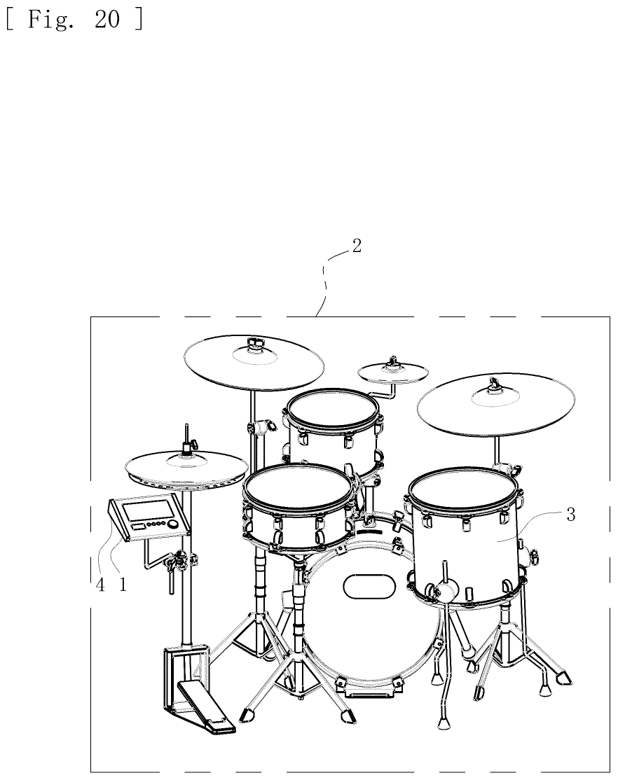

Although the present embodiments have so far been described, the present disclosure is not limited. For example, as illustrated in FIGS. 19, 20, the electronic musical instrument operating device 1 may be formed by integrating with the sound source part 4 of the electronic musical instrument 2. As illustrated in FIGS. 19, 20, the electronic musical instrument operating device 1 is formed by integrating with the sound source part 4 of the electronic musical instrument 2. It includes a display 5 comprised of a display screen, an input part 6 configured to receive input by detecting a touch operation to the display 5, a display control part 7 comprised of a microcomputer, a reflection part 8 configured to receive a touch operation by an operator and a determining part 9 comprised of a microcomputer.

In addition, in the above-described embodiment, the determining part 9 is provided, but the determining part 9 may not be provided. In the present embodiment, the reflection part 8 is displayed on the display 5. Each parameter of the electronic musical instrument 2 reflects a desired value rather the current value by performing a touch operation on the reflection part 8. However, the reflection part 8 may be displayed on a display different from the display 5, or it may be comprised of a mechanical lever switch or a pressing button. In addition, the first display form and the second display form are not limited to the display of the present embodiment, and it is sufficient that the display forms be different from each other.

The present disclosure is applicable to an electronic musical instrument operating device as well as the electronic musical instrument operating device with a different appearance shape or another additional function. Accordingly, the electronic musical instrument operating device includes: a display configured to display a current value of the parameter of the electronic musical instrument in a first display form; a touch panel input part configured to receive input of a desired value of the parameter of the electronic musical instrument; a display control part configured to display the desired value of the parameter of the electronic musical instrument, received by the input part in a second display form different from the first display form; and a reflection part configured to reflect the change in the parameter of the electronic musical instrument from the current value to the desired value, provided that a relevant operation by an operator is performed. Thus, the display control part restores the desired value displayed in the second display form on the display to the first display form, provided that a reflection operation of reflecting the desired value on the parameter of the electronic musical instrument is performed.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electronic musical instrument operating device configured to operate any parameter related to output of a sound source part included in an electronic musical instrument, the electronic musical instrument operating device comprising:
a display configured to display a current value of the parameter of the electronic musical instrument in a first display form;
a touch panel input configured to receive input of a desired value of the parameter of the electronic musical instrument;
a display control configured to display the desired value of the parameter of the electronic musical instrument, received by the input in a second display form different from the first display form; and
a reflection part configured to reflect the change in the parameter of the electronic musical instrument from the current value to the desired value, provided that a relevant operation is performed by an operator,
wherein the display control restores the desired value displayed in the second display form on the display to the first display form, provided that a reflection operation of changing the parameter of the electronic musical instrument to the desired value is performed.

2. The electronic musical instrument operating device according to claim 1, further comprising:
a determining part configured to determine whether the parameter of the electronic musical instrument is changed to the desired value,
wherein the display control restores the desired value displayed in the second display form on the display to the first display form, provided that the parameter of the electronic musical instrument is determined to be changed to the desired value by the determining part.

3. The electronic musical instrument operating device according to claim 1, wherein the electronic musical instrument includes a plurality of performance parts, and the display control is configured to individually control display of the plurality of performance parts.

4. An electronic musical instrument operating device configured to operate any parameter related to output of a sound source part included in an electronic musical instrument, the electronic musical instrument operating device comprising:
a display configured to display a current value of the parameter of the electronic musical instrument;
a touch panel input configured to receive input of a desired value of the parameter of the electronic musical instrument;
a display control configured to, upon input of a desired value of the parameter of the electronic musical instrument received by the input part, change a first display state to a second display state, and display presence or absence of the desired value;
a reflection part configured to reflect the change in the parameter of the electronic musical instrument from the current value to the desired value, provided that a relevant operation is performed by an operator;
a restoring part configured to restore the desired value which has not been reflected on the electronic musical instrument to the current value, provided that a relevant operation is performed by an operator; and
a determining part configured to determine presence or absence of the desired value that has not been reflected on the electronic musical instrument,
wherein the display control restores display in the second display state on the display to the first display state, provided that the determining part determines absence of the desired value which has not been reflected on the electronic musical instrument.

5. The electronic musical instrument operating device according to claim 1, wherein the input is configured to receive input of a plurality of desired values each of which is the desired value of the parameter of the electronic musical instrument, and the reflection part causes the plurality of desired values to be collectively reflected on, provided that a relevant operation is performed by an operator.

6. The electronic musical instrument operating device according to claim 1, wherein the parameter includes sound volume, sound quality, music sound, sound effect, setting of an output destination of the electronic musical instrument, and adjustment items of the performance parts.

7. The electronic musical instrument operating device according to claim 1, wherein the electronic musical instrument operating device is comprised of an external operating terminal connected to the sound source part of the electronic musical instrument by a wire or wirelessly.

8. The electronic musical instrument operating device according to claim 4, wherein the input is configured to receive input of a plurality of desired values each of which is the desired value of the parameter of the electronic musical instrument, and the reflection part causes the plurality of desired values to be collectively reflected on, provided that a relevant operation is performed by an operator.

9. The electronic musical instrument operating device according to claim 4, wherein the parameter includes sound volume, sound quality, music sound, sound effect, setting of an output destination of the electronic musical instrument, and adjustment items of the performance parts.

10. The electronic musical instrument operating device according to claim 4, wherein the electronic musical instrument operating device is comprised of an external operating terminal connected to the sound source part of the electronic musical instrument by a wire or wirelessly.
